(19) United States
(12) Patent Application Publication
(10) Pub. No.: US 2010/0079522 A1
(43) Pub. Date: Apr. 1, 2010

(54) FLUID EJECTION DEVICE, DRIVING METHOD OF FLUID EJECTION DEVICE, AND OPERATING INSTRUMENT

(75) Inventors: Takeshi SETO, Chofu-shi (JP); Kazuo KAWASUMI, Chino-shi (JP); Yasuyoshi HAMA, Shimosuwa-machi (JP); Hideki KOJIMA, Matsumoto-shi (JP); Yasuhiro ONO, Matsumoto-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/559,001

(22) Filed: Sep. 14, 2009

(30) Foreign Application Priority Data
Sep. 30, 2008 (JP) 2008-252675

(51) Int. Cl. B41J 29/38

(52) U.S. Cl. 347/14

(57) ABSTRACT

A fluid ejection device includes: a fluid chamber whose capacity is variable; an inlet flow path and an outlet flow path communicating with the fluid chamber; a capacity changing unit which changes the capacity of the fluid chamber; a fluid supplying unit which supplies fluid to the inlet flow path; a fluid ejection opening disposed at an end of the outlet flow path opposite to an end communicating with the fluid chamber; a first electrode of a predetermined polarity having a first contact portion disposed at the fluid ejection opening or a component in the vicinity of the fluid ejection opening; a second electrode having a polarity different from the predetermined polarity and having a second conductive contact portion; a conduction judging unit which judges whether the first electrode and the second electrode are conducted; and an operation control unit which controls operation of the capacity changing unit based on judgment result of the conduction judging unit.

Japanese Patent Application No. 2008-252675 filed on Sep. 30, 2008, is hereby incorporated by reference in its entirety.

### BACKGROUND

1. Technical Field

The present invention relates to a fluid ejection device which ejects fluid at high speed, and more particularly to a fluid ejection device, a driving method of a fluid ejection device, and an operating instrument capable of controlling fluid ejection according to contact condition between an ejection target object and an ejection end.

2. Related Art

A fluid ejection device which opens or removes tissue of a living body by cutting has been proposed by the present inventors (see JP-A-2008-82202).

This fluid ejection device includes: a pulse generating unit which has a fluid chamber whose capacity is variable, inlet flow path and outlet flow path communicating with the fluid chamber, a capacity changing unit for changing the capacity of the fluid chamber according to supply of driving signals; a connection flow path which has one end communicating with the outlet flow path and the other end having a fluid ejection opening (nozzle) whose diameter is smaller than that of the outlet flow path; a connection flow pipe containing the connection flow path and having rigidity sufficient for transmitting pulse of fluid flowing from the fluid chamber to the fluid ejection opening; and a pressure generating unit which generates pressure for supplying fluid to the inlet flow path. The fluid ejection device supplies fluid to the inlet flow path with constant pressure produced by the pressure generating unit, and generates pulse by changing the capacity of the fluid chamber using the capacity changing unit to deliver fluid.

When the capacity of the fluid chamber of the fluid ejection device is not changed, fluid flows under the balanced condition between supply pressure produced by the pressure generating unit and fluid path resistance. In this condition, delivery of fluid from the nozzle is continuous at low speed, producing substantially no tissue cutting capability.

When the capacity of the fluid chamber is rapidly decreased, the pressure of the fluid chamber increases. In this condition, increase in the flow amount of fluid delivered from the outlet flow path is larger than decrease in the flow amount of fluid flowing into the fluid chamber from the inlet flow path. Thus, pulsed flow is generated in the connection flow path. This pressure change at the time of delivery is transmitted through the connection flow path pipe such that fluid can be ejected from the fluid ejection opening formed at the end of the nozzle at high speed.

By repeating this operation, fluid can be delivered by high-speed pulse jet. In this structure, starting and stopping at the speed of several msec. or less can be achieved by contracting and expanding the fluid chamber using a piezoelectric element.

This technology is applicable to a fluid ejection device disclosed in another reference (see JP-A-2005-152127) proposed by the present inventors as ejection device requiring no pressure generating unit.

When the fluid ejection device in the related art discussed above is used as a water scalpel in an operation, the operation is performed with the nozzle almost closely attached to the affected part. Thus, when the nozzle ejecting fluid at high pressure is separated from the affected part, liquid drops produced by the fluid ejection are scattered. In this case, there is a possibility that removed pieces of tissue containing cancer or the like are scattered around.

### SUMMARY

It is an advantage of some aspects of the invention to provide a fluid ejection device, a driving method of a fluid ejection device, and an operating instrument capable of controlling fluid ejection operation according to contact condition between an ejection target object and an ejection end.

### First Aspect

A first aspect of the invention is directed to a fluid ejection device including: a fluid chamber whose capacity is variable; an inlet flow path and an outlet flow path communicating with the fluid chamber; a capacity changing unit which changes the capacity of the fluid chamber; a fluid supplying unit which supplies fluid to the inlet flow path; a fluid ejection opening disposed at an end of the outlet flow path opposite to an end communicating with the fluid chamber; a first electrode of a predetermined polarity having a first contact portion disposed at the fluid ejection opening or a component in the vicinity of the fluid ejection opening; a second electrode having a polarity different from the predetermined polarity and having a second conductive contact portion; a conduction judging unit which judges whether the first electrode and the second electrode are conducted; and an operation control unit which controls operation of the capacity changing unit based on judgment result of the conduction judging unit.

According to this structure, the first contact portion provided on the fluid ejection opening or the component in the vicinity of the fluid ejection opening contacts an ejection target objector an object such as liquid between which and the ejection target object continuity is produced under the condition in which the second contact portion contacts the ejection target object for fluid such as a human body through which current can flow. In this case, the first contact portion provided on the fluid ejection opening or the component in the vicinity of the fluid ejection opening contacts the ejection target object or the object between which and the ejection target object continuity can be produced. As a result, the first electrode and the second electrode are conducted via the ejection target object or the object between which and the ejection target object continuity can be produced, and thus the conduction judging unit determines that conduction of the first electrode and the second electrode has been achieved.

When at least either the first contact portion or the second contact portion is separated from the ejection target object or the object between which and the ejection target object continuity can be produced, the first electrode and the second electrode are not conducted. As a result, the conduction judging unit determines that conduction of the first electrode and the second electrode is not achieved.

That is, when the fluid ejection opening or the component in the vicinity of the fluid ejection opening contacts the ejection target object or the object between which and the ejection target object continuity can be produced with the second contact portion contacting the ejection target object, the first electrode and the second electrode are conducted. On the other hand, when the fluid ejection opening or the component in the vicinity of the fluid ejection opening does not contact the ejection target object or the object between which and the ejection target object continuity can be produced, the first electrode and the second electrode are not conducted.

When it is determined that conduction of the first electrode and the second electrode has been achieved by the conduction judging unit, the operation control unit allows the capacity changing unit to change the capacity based on the judgment result, for example.

When it is determined that conduction of the first electrode and the second electrode is not achieved by the conduction judging unit, the operation control unit controls the capacity changing unit not to change the capacity or decrease ejection force of fluid based on the judgment result, for example.

Since control such as stopping ejection operation or decreasing ejecting force can be performed when the first electrode and the second electrode are not conducted, ejection of fluid in an unexpected direction and scattering of tissue pieces cut by the ejection in the unexpected direction can be prevented when the fluid ejection opening or the component in the vicinity of the fluid ejection opening is separated from the ejection target object or the object between which and the ejection target object continuity can be produced by operation error of the user (such as operator) or the like.

### Second Aspect

A second aspect of the invention is directed to the fluid ejection device of the first aspect, wherein the second electrode has an attachment member which attaches the second contact portion of the second electrode such that the second contact portion contacts an ejection target object for the fluid.

According to this structure, the second electrode can be attached by the attachment member such that the second contact portion contacts the ejection target object such as a human body through which current can flow. In this case, the first electrode and the second electrode can be conducted via the ejection target object (and the object between which and the ejection target object continuity can be produced) by bringing the fluid ejection opening or the component in the vicinity of the fluid ejection opening into contact with the ejection target object or the surrounding object between which and the ejection target object continuity can be produced with the second electrode attached. Also, conduction of the first electrode and the second electrode can be prevented by separating (cutting contact of) the first electrode from the ejection target object or the object between which and the ejection target object continuity can be produced.

### Third Aspect

A third aspect of the invention is directed to the fluid ejection device of the first or second aspect, wherein the fluid ejection opening or the component in the vicinity of the fluid ejection opening is made of conductive material and forms the first contact portion of the first electrode.

According to this structure, the first contact portion is constituted by the component originally provided on the device. Thus, the necessity for providing an additional first contact portion is eliminated, and the first electrode can be produced at relatively low cost.

### Fourth Aspect

A fourth aspect of the invention is directed to the fluid ejection device of the first aspect, wherein the first electrode is disposed at the fluid ejection opening, and the second electrode is disposed on the component in the vicinity of the fluid ejection opening.

According to this structure, the first electrode and the second electrode can be conducted via the ejection target object such as human body through which current can flow by bringing the fluid ejection opening or the component in the vicinity of the fluid ejection opening into contact with the human body, for example. Also, conduction of the first electrode and the second electrode can be suspended by separating the fluid ejection opening or the component in the vicinity of the fluid ejection opening from the human body.

By this configuration, the necessity for attaching the second electrode to the ejection target object before use or other processes can be eliminated, and the usability can be improved.

### Fifth Aspect

A fifth aspect of the invention is directed to the fluid ejection device of the fourth aspect, wherein the fluid ejection opening and the component in the vicinity of the fluid ejection opening are made of conductive material. The fluid ejection opening forms the first contact portion of the first electrode. The component in the vicinity of the fluid ejection opening forms the second contact portion of the second electrode.

According to this structure, the first contact portion and the second contact portion are constituted by the components originally provided on the device. Thus, the necessity for providing additional first contact portion and second contact portion is eliminated, and the first electrode and the second electrode can be produced at relatively low cost.

### Sixth Aspect

A sixth aspect of the invention is directed to the fluid ejection device of the first aspect, wherein the first contact portion and the second contact portion are provided on the component in the vicinity of the fluid ejection opening.

According to this structure, the first electrode and the second electrode can be conducted via the ejection target object such as human body through which current can flow by bringing the fluid ejection opening or the component in the vicinity of the fluid ejection opening into contact with the human body, for example. Also, conduction of the first electrode and the second electrode can be suspended by separating the fluid ejection opening or the component in the vicinity of the fluid ejection opening from the human body.

By this configuration, the necessity for attaching the second electrode to the ejection target object before use or other processes can be eliminated, and the usability can be improved.

Since the first contact portion and the second contact portion are provided only on the component in the vicinity of the fluid ejection opening, the first electrode and the second electrode can be produced at lower cost than that of the structure having the first and second contact portions on both the fluid ejection opening and the component in the vicinity of the fluid ejection opening.

### Seventh Aspect

A seventh aspect of the invention is directed to the fluid ejection device of the sixth aspect, wherein the component in the vicinity of the fluid ejection opening is made of conductive material. The first contact portion and the second contact portion are disposed on the component in the vicinity of the fluid ejection opening via an insulator such that the first electrode and the second electrode are not conducted when the first contact portion and the second contact portion do not contact the ejection target object.

According to this structure, the first contact portion and the second contact portion can be produced by applying insulation processing to the part originally constituting the component in the vicinity of the fluid ejection opening.

By this configuration, the necessity for attaching the second electrode to the ejection target object before use and other processing is eliminated, and the usability is improved.

### Eighth Aspect

An eighth aspect of the invention is directed to the fluid ejection device of the first or second aspect, wherein the fluid ejection device further includes: a high-frequency current applying unit which applies high-frequency current between the first electrode and the second electrode; and a switching unit which electrically disconnects the first and second electrodes from the conduction judging unit and electrically connects the first and second electrodes to the high-frequency current applying unit when the high-frequency current applying unit applies high-frequency current.

According to this structure, the high-frequency current applying unit applies high-frequency current between the first electrode and the second electrode. Thus, the fluid ejection device can provide function of electric scalpel as well as function of water scalpel by fluid ejection.

Thus, treatment such as hemostasis by blood coagulation using the electric scalpel can be carried out at the time of unexpected bleeding.

### Ninth Aspect

A ninth aspect of the invention is directed to the fluid ejection device of any of the first to eighth aspects, wherein the fluid ejection device further includes: a suction pipe which contains a suction opening provided in the vicinity of the fluid ejection opening and a passage through which a sucked object passes; and a sucking force giving unit which gives sucking force for sucking object in the vicinity of the opening of the suction pipe.

According to this structure, the fluid ejected through the fluid ejection opening and the object cut or removed (such as tissue pieces) by fluid ejection can be sucked by the sucking force given by the sucking force giving unit.

By this configuration, cut tissue pieces or discharged fluid can be sucked by the fluid ejection device used as water scalpel during operation. Thus, operation can be performed with preferable field of vision secured.

Moreover, current flowing through the passage of the suction pipe can be transmitted to the vicinity of the fluid chamber by constituting the suction pipe by conductive material and forming the first contact portion of the first electrode on the opening of the suction pipe. Thus, wiring necessary for producing the first electrode can be simplified.

### Tenth Aspect

A tenth aspect of the invention is directed to the fluid ejection device of any of the first to ninth aspects, wherein the fluid ejection device further includes a connection flow path communicating with the outlet flow path at a first end and having the fluid ejection opening at a second end to transmit pulse of fluid flowing from the fluid chamber to the other end.

According to this structure, the distance between the fluid chamber and the fluid ejection opening can be increased. Thus, the fluid ejection device can be used as water scalpel for operation applied to portions at deep positions such as brain operation.

### Eleventh Aspect

An eleventh aspect of the invention is directed to the fluid ejection device of the ninth aspect, wherein the connection flow path pipe is made of conductive material.

According to this structure, current flowing through the first contact portion can be transmitted to the vicinity of the fluid chamber via the connection flow path pipe by forming the first contact portion of the first electrode on the fluid ejection opening. Thus, wiring necessary for producing the first electrode can be simplified.

### Twelfth Aspect

A twelfth aspect of the invention is directed to any of the first to eleventh aspects, wherein the fluid supplying unit has a pressure generating unit which generates pressure for supplying the fluid to the fluid chamber.

According to this structure, fluid can be supplied to the inlet flow path with constant pressure by using the pressure generating unit. Thus, fluid can be supplied to the inlet flow path and the fluid chamber with the operation of the capacity changing unit stopped.

Accordingly, the initial operation can be started without priming the pump.

The pressure generating unit is a pump for delivering fluid with constant pressure, for example.

### Thirteenth Aspect

A thirteenth aspect of the invention is directed to the fluid ejection device of any of the first to twelfth aspects, wherein the operation control unit allows operation of the capacity changing unit when the conduction judging unit determines that conduction of the first electrode and the second electrode has been achieved, and prohibits operation of the capacity changing unit when the conduction judging unit determines that conduction of the first electrode and the second electrode is not achieved.

According to this structure, fluid ejection can be performed when the first electrode and the second electrode are conducted. Also, fluid ejection can be stopped when the first electrode and the second electrode are not conducted.

Thus, high-pressure fluid ejection in an expected direction and scattering of object cut or removed thereby can be prevented even when the fluid ejection opening or the component in the vicinity of the fluid ejection opening is separated from the ejection target object or the object between which and the ejection target object continuity can be produced.

### Fourteenth Aspect

A fourteenth aspect of the invention is directed to a driving method of a fluid ejection device comprising: the fluid ejection device including a fluid chamber whose capacity is variable, an inlet flow path and an outlet flow path communicating with the fluid chamber, a capacity changing unit which changes the capacity of the fluid chamber, a fluid supplying unit which supplies fluid to the inlet flow path, a fluid ejection opening disposed at an end of the outlet flow path opposite to an end communicating with the fluid chamber, a first electrode having a first conductive contact portion contacting an ejection target object for the fluid and disposed at the fluid ejection opening or a component in the vicinity of the fluid ejection opening, a second electrode having a polarity different from that of the first electrode and having a second conductive contact portion contacting the ejection target object, a conduction judging unit which judges whether the first electrode and the second electrode are conducted, and an operation control unit which controls operation of the capacity changing unit based on judgment result of the conduction judging unit; judging conduction by causing the conduction judging unit to judge whether the first electrode and the second electrode are conducted; and controlling operation of the capacity changing unit by causing the operation control unit to control the capacity changing unit based on judgment result of the conduction judging step.

According to this method, operations and advantages similar to those of the fluid ejection device of the first aspect described above can be provided.

### Fifteenth Aspect

A fifteenth aspect of the invention is directed to an operating instrument which supports medical treatment for an affected portion using ejection of fluid, including the fluid ejection device of any of the first to thirteenth aspects.

According to this structure, medical treatment for cutting and removing an affected portion such as tumor can be supported by the ejection of fluid provided by the fluid ejection device of any of the first to thirteenth aspects described above.

### BRIEF DESCRIPTION OF THE DRAWINGS

The invention will be described with reference to the accompanying drawings, wherein like numbers reference like elements.

FIG. 1 illustrates a general structure of a fluid ejection device according to a first embodiment.

FIG. 2 is a cross-sectional view of a structure of a pulse generating unit according to the first embodiment.

FIG. 3 illustrates a disassembled fluid ejection part of the fluid ejection device.

FIG. 4 is a plan view showing an inlet flow path.

FIG. 5 is a block diagram showing a detailed structure of a drive unit.

FIG. 6 illustrates a structure of a first electrode.

FIG. 7 shows a wiring structure of an electrode line and drive signal supply lines of the first electrode.

FIG. 8 is a flowchart showing a process performed when the first electrode and a second electrode are connected with an conduction judging section with a drive switch of an electric scalpel turned off.

FIG. 9 is a flowchart showing a drive signal supply process performed by a drive signal supplying section.

FIG. 10 illustrates a general structure of a fluid ejection device according to a second embodiment.

FIG. 11A illustrates structures of the first electrode and a second electrode, and FIG. 11B is a cross-sectional view taken along a line B-B′ in FIG. 11A.

FIG. 12A is a cross-sectional view illustrating a first structure of the first electrode and the second electrode, and FIG. 12B is a cross-sectional view illustrating a second structure of the first electrode and the second electrode.

FIG. 13A is a cross-sectional view illustrating a third structure of the first electrode and the second electrode, and FIG. 13S is a cross-sectional view showing a nozzle, a connection flow path and a suction pipe taken along a line C-C′ in FIG. 13A.

### DESCRIPTION OF EXEMPLARY EMBODIMENTS

### First Embodiment

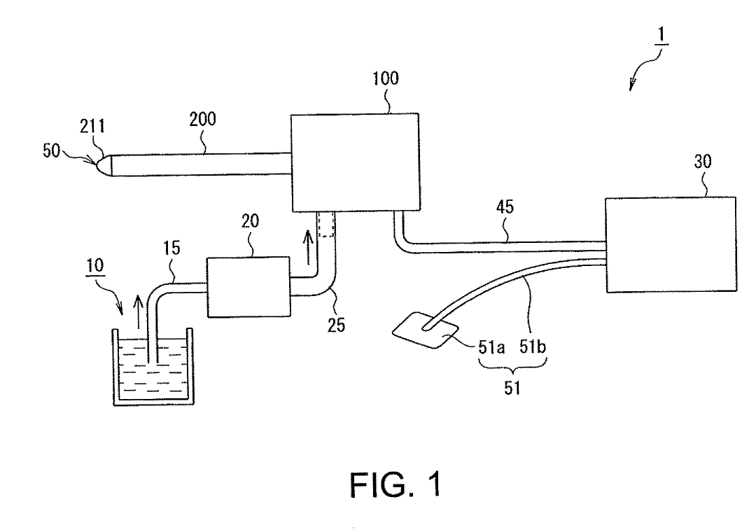

A first embodiment of the invention is hereinafter described with reference to the drawings. FIGS. 1 through 9 show a fluid ejection device, a driving method of the fluid ejection device, and an operating instrument according to the first embodiment.

The fluid ejection device according to the invention can be used for various applications such as drawing by ink or the like, cleaning of minute object and structure, cutting and removal of objects, and operation scalpels. In this embodiment, the fluid ejection device appropriately used for opening or removing tissue of a living body by cutting will be described as an example. Thus, fluid used in this embodiment is water, physiological salt water, liquid medicine or the like.

Initially, the structure of the fluid ejection device according to this embodiment is explained with reference to FIG. 1. FIG. 1 illustrates a general structure of a fluid ejection device 1 according to this embodiment.

As illustrated in FIG. 1, the fluid ejection device 1 has a basic structure including a fluid container 10 for storing fluid, a pump 20 as a pressure generating unit, a pulse generating unit 100 for generating pulse flow of fluid received from the pump 20, a drive unit 30 for driving the pulse generating unit 100, a first electrode 50, and a second electrode 51.

The pulse generating unit 100 is connected with a pipe-shaped narrow connection flow path pipe 200. A nozzle 211 having a smaller diameter than the flow path diameter of the connection flow path pipe 200 is inserted into the end of the connection flow path pipe 200.

The connection flow path pipe 200 is made of conductive material, and the outer circumference of the connection flow path pipe 200 is coated with insulator.

The nozzle 211 is made of conductive material, and functions as a first contact portion of the first electrode 50 as positive electrode. Continuity can be produced between the nozzle 211 and the connection flow path pipe 200 via the insertion portion. The detailed structure of the first electrode 50 will be described later.

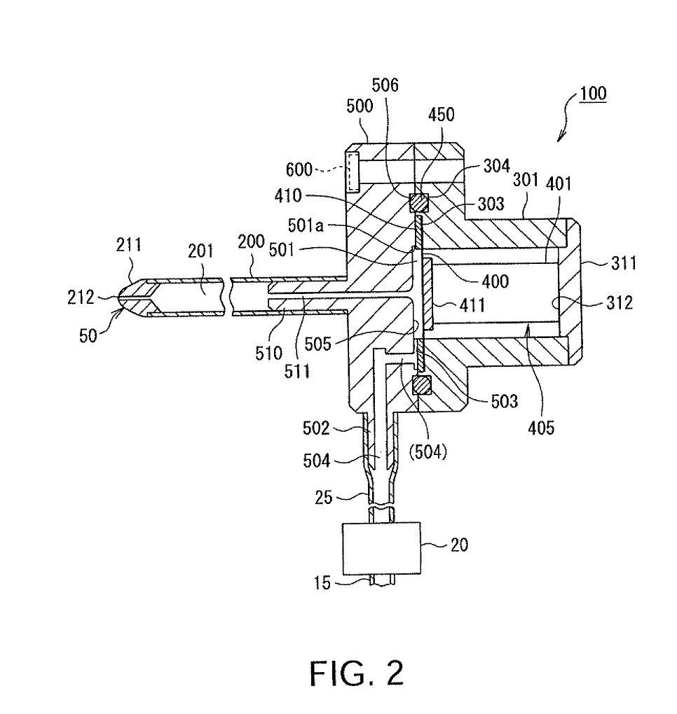

A cable 45 contains an electrode line, and continuity is produced between the electrode line and the nozzle 211 constituting the first contact portion of the first electrode 50 via the connection flow path pipe 200. The cable 45 also contains supply lines for supplying driving signals to a capacity changing unit 405 (see FIG. 2). The cable 45 extends from the pulse generating unit 100, and the respective lines of the cable 45 are electrically connected with the corresponding components of the drive unit 30.

The second electrode 51 as negative electrode includes a second contact portion 51a and a cable 51b.

The second contact portion 51a has a adhesive attachment portion to be affixed to a fluid ejection target such as a human body such that the conductive portion electrically connected with the cable 51b can contact the ejection target.

One end of the cable 51b is electrically connected with the conductive portion of the second contact portion 51a, and the other end of the cable 51b is electrically connected with the drive unit 30.

The flow of fluid in the fluid ejection device 1 is now briefly described with reference to FIGS. 1 and 2.

FIG. 2 is a cross-sectional view showing the structure of the pulse generating unit 100 in this embodiment. In FIG. 2, the left-right direction corresponds to the up-down direction. FIG. 2 is a cross-sectional view taken along a line A-A′ in FIG. 4.

The fluid stored in the fluid container 10 is sucked through a connection tube 15 using the pump 20, and supplied to the pulse generating unit 100 via a connection tube 25 with constant pressure. The pulse generating unit 100 has a fluid chamber 501, and the capacity changing unit 405 for changing the capacity of the fluid chamber 501 according to drive signals sent from the drive unit 30. The pulse generating unit 100 generates pulse by operation of the capacity changing unit 405, and ejects fluid at high speed through the connection flow path pipe 200 and the nozzle 211. The details of the pulse generating unit 100 will be explained later.

Pressure is not required to be generated by using the pump 20 but may be produced by supporting a liquid carry bag at a position higher than the pulse generating unit 100 using a stand or the like. In this case, the pump 20 can be eliminated. Moreover, advantages such as simplification of the structure and easy disinfection can be provided.

The delivery pressure of the pump 20 is set at about 3 atm. (0.3 MPa) or lower. When the liquid carry bag is used, the pressure corresponds to the height difference between the pulse generating unit 100 and the liquid level of the liquid carry bag. It is preferable that the height difference is so determined as to produce pressure in the range from 0.1 to 0.15 atm. (0.01 to 0.15 MPa) when the liquid carry bag is used.

While performing operation using the fluid ejection device 1, the operator holds the pulse generating unit 100. In this case, it is preferable that the connection tube 25 extending to the pulse generating unit 100 is flexible as much as possible. Accordingly, the connection tube 25 is preferably a flexible and narrow tube which produces the lowest possible pressure sufficient for supplying liquid to the pulse generating unit 100.

Particularly when failure of the device leads to serious accidents in such cases as brain operation, ejection of high-pressure fluid caused by cutting of the connection tube 25 or the like must be avoided. For this reason, the pressure of the connection tube 25 is required to be kept low.

The structure of the pulse generating unit 100 is now discussed with reference to FIGS. 2 through 4.

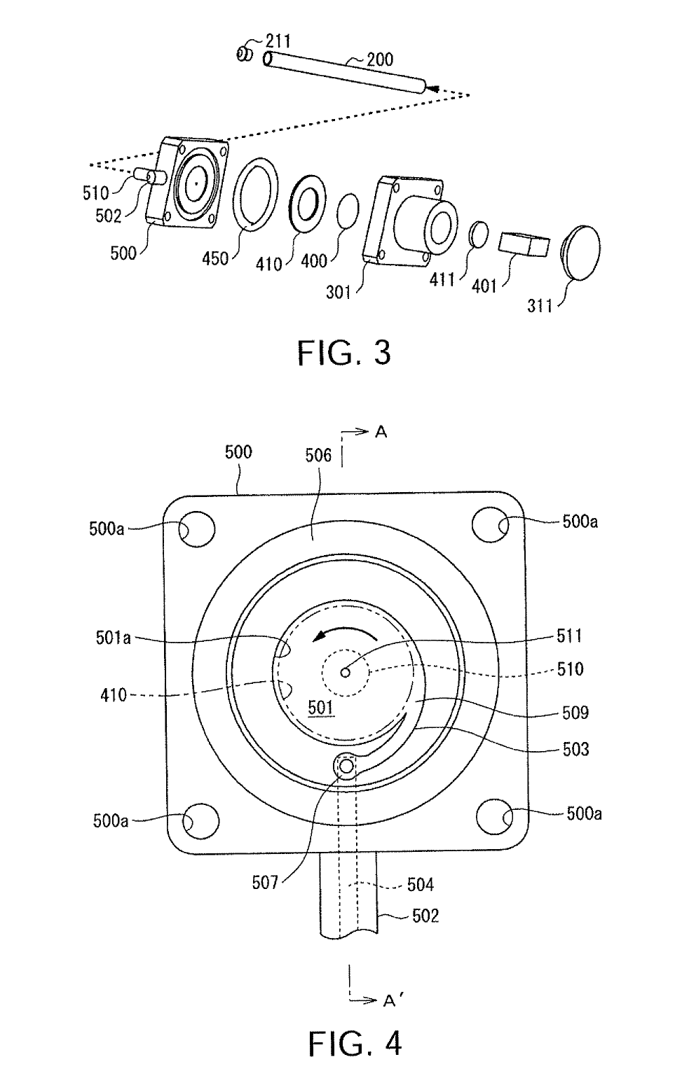

FIG. 3 illustrates a disassembled fluid ejection area of the fluid ejection device 1. FIG. 4 is a plan view showing an inlet flow path 503 on an upper case 500 as viewed from a junction surface connected with a lower case 301.

As illustrated in FIGS. 2 through 4, the pulse generating unit 100 includes the upper case 500 having screw holes 500a at the four corners, and the lower case 301 having screw holes 301a (not shown) at the four corners. The upper case 500 and the lower case 301 are joined such that the corresponding screw holes 500a and 301a are opposed to one another on the junction surfaces, and fixed to each other by inserting four fixing screws 600 (partially not shown) into the screw holes 500a and 301a.

The lower case 301 is a hollow cylindrical component having a fringe portion, and one end of the lower case 301 is closed by a bottom plate 311. A piezoelectric element 401 as one of the components constituting the capacity changing unit 405 is provided in the space inside the lower case 301.

The piezoelectric element 401 is a lamination type piezoelectric element constituting an actuator. One end of the piezoelectric element 401 is fixed to a diaphragm 400 via an upper plate 411, and the other end is fixed to an upper surface 312 of the bottom plate 311.

The diaphragm 400 is formed by a disk-shaped metal thin plate, and the circumferential area of the diaphragm 400 is disposed within an annular concave 303 formed on the upper surface of the lower case 301 to be closely fixed to the bottom surface of the concave 303. A reinforcing plate 410 formed by disk-shaped metal thin plate and having a circular opening at the center is laminated on the upper surface of the diaphragm 400.

According to this structure, the piezoelectric element 401 expands and contracts in response to drive signals inputted to the piezoelectric element 401 (operation voltage applied) from the drive unit 30. Then, the upward force at expansion and the downward force at contraction move the upper plate 411 in the up-down direction. By movement of the upper plate 411, the diaphragm 400 deforms and changes the capacity of the fluid chamber 501.

Thus, the capacity changing unit 405 is constituted by the piezoelectric element 401, the upper plate 411, the diaphragm 400, and the reinforcing plate 410.

The upper case 500 has a circular concave at the center of the surface opposed to the lower case 301. The fluid chamber 501 corresponds to a rotation body formed by this circular concave and the diaphragm 400 and filled with fluid inside. Thus, the fluid chamber 501 is a space surrounded by a sealing surface 505 and an inner circumferential side wall 501a of the concave of the upper case 500 and the diaphragm 400. An outlet flow path 511 is formed substantially at the center of the fluid chamber 501.

The outlet flow path 511 extends from the fluid chamber 501 to the end of the outlet flow path pipe 510 projecting from one end surface of the upper case 500. The connecting portion between the outlet flow path 511 and the sealing surface 505 of the fluid chamber 501 is smoothly rounded to reduce fluid resistance.

While the shape of the fluid chamber 501 in this embodiment has a substantially cylindrical shape with both ends sealed, the shape may be conical, trapezoidal, semispherical in the side view, or any arbitrary shapes. When the connecting portion between the outlet flow path 511 and the sealing surface 505 is funnel-shaped, for example, bubbles in the fluid chamber 501 as will be described later can be easily discharged.

The connection flow path pipe 200 is connected with the outlet flow path pipe 510. The connection flow path pipe 200 has a connection flow path 201 whose diameter is larger than that of the outlet flow path 511. The thickness of the pipe of the connection flow path pipe 200 is set in such a range that the connection flow path pipe 200 has rigidity sufficient for absorbing no pressure pulse of fluid.

The nozzle 211 is inserted into the end of the connection flow path pipe 200. The nozzle 211 has a fluid ejection opening 212. The diameter of the fluid ejection opening 212 is smaller than that of the connection flow path 201.

An inlet flow path pipe 502 to which the connection tube 25 for supplying fluid from the pump 20 is attached is formed on the side surface of the upper case 500. The inlet flow path pipe 502 has an inlet flow path side connection flow path 504. The connection flow path 504 communicates with the inlet flow path 503. The inlet flow path 503 is formed on the periphery of the sealing surface 505 of the fluid chamber 501 in the shape of groove, and communicates with the fluid chamber 501.

A packing box 304 on the lower case 301 side and a packing box 506 on the upper case 500 side are provided on the junction surface between the upper case 500 and the lower case 301 at positions away from the diaphragm 400 in the outer circumferential direction. Also, a ring-shaped packing 450 is inserted into the space formed by the packing boxes 304 and 506.

When the upper case 500 and the lower case 301 are assembled, the periphery of the diaphragm 400 and the periphery of the reinforcing plate 410 are brought into close contact with each other by the periphery of the sealing surface 505 of the upper case 500 and the bottom surface of the concave 303 of the lower case 301. In this case, the packing 450 is pressed by the upper case 500 and the lower case 301 to prevent fluid leakage from the fluid chamber 501.

The inside space of the fluid chamber 501 has high pressure such as 30 atm. (3 MPa) or higher at the time of fluid delivery. In this case, there is a possibility of slight leakage of fluid through the connecting portions of the diaphragm 400, the reinforcing plate 410, the upper case 500, and the lower case 301. However, such leakage can be prevented by the function of the packing 450.

The packing 450 disposed as illustrated in FIG. 2 is compressed by pressure of fluid leaking from the fluid chamber 501 with high pressure, and further strongly pressed by the inside walls of the packing boxes 304 and 506. Thus, leakage of fluid can be more securely prevented. Accordingly, high pressure increase inside the fluid chamber 501 can be maintained during operation.

The inlet flow path 503 formed on the upper case 500 is now explained in more detail.

As illustrated in FIG. 4, the inlet flow path 503 has a groove formed on the periphery of the sealing surface 505 of the upper case 500 and the reinforcing plate 410 fixed to the sealing surface 505 with pressure.

One end of the inlet flow path 503 communicates with fluid chamber 501, and the other end communicates with the connection flow path 504. A fluid reservoir 507 is provided on the connection portion between the inlet flow path 503 and the connection flow path 504. The connection portion between the fluid reservoir 507 and the inlet flow path 503 is smoothly rounded to reduce fluid resistance.

The inlet flow path 503 communicates with the inner circumferential side wall 501a of the fluid chamber 501 substantially in the tangential direction. The fluid supplied from the pump 20 with constant pressure flows along the inner circumferential side wall 501 (in the direction indicated by an arrow in the figure) to generate rotational flow in the fluid chamber 501. Bubbles having low density and contained in the fluid chamber 501 gather at the center of the rotational flow due to centrifugal force of the rotational flow.

The bubbles gathered at the center are discharge through the outlet flow path 511. Thus, it is preferable that the outlet flow path 511 is disposed in the vicinity of the center of the rotational flow, that is, the axial center of the rotation body. According to the example shown in FIG. 4, the shape of the inlet flow path 503 in the plan view is curved in spiral shape. The inlet flow path 503 may have a linear shape communicating with the fluid chamber 501, but is curved in this embodiment so as to obtain desired inertance in the narrow space by increasing the flow path length of the inlet flow path 503.

As illustrated in FIG. 2, the reinforcing plate 410 is provided between the diaphragm 400 and the periphery of the sealing surface 505 on which the inlet flow path 503 is formed. The reinforcing plate 410 is provided for the purpose of increasing durability of the diaphragm 400. Since a notch-shaped connection opening 509 is formed on the connecting portion between the inlet flow path 503 and the fluid chamber 501, it is considered that fatigue breakage is caused by stress concentration in the vicinity of the connection opening 509 when the diaphragm 400 is operated at high frequency. Thus, the reinforcing plate 410 having continuous opening without notch is provided to prevent stress concentration generated on the diaphragm 400.

According to the fluid ejection device 1 having this structure, the screw holes 500a are formed at the four corners of the outer periphery of the upper case 500 such that the upper case 500 and the lower case 301 can be connected with each other by screws inserted into the screw holes 500a. However, the reinforcing plate 410 and the diaphragm 400 may be connected and fixed to one another in lamination as one piece unit, for example, though not shown in the figure. The reinforcing plate 410 and the diaphragm 400 may be fixed by adhesive, fixed layer diffused junction, welding or other fixing methods. It is preferable that the reinforcing plate 410 and the diaphragm 400 are closely connected with each other via the junction surface.

According to the fluid ejection device 1 having this structure, the outlet flow path 511 and the nozzle 211 are connected with each other via the connection flow path pipe 200. However, the nozzle 211 may be inserted into the end of the outlet flow path pipe 510 on the side opposite to the fluid chamber 501 without using the connection flow path pipe 200. In this case, the structure can be further simplified.

When the fluid ejection device 1 is used in operation, it is preferable that the connection flow path pipe 200 is used so as to appropriately increase the distance between a handpiece and the fluid ejection opening 212.

The principle of the fluid delivery performed by the pulse generating unit 100 according to this embodiment is now discussed.

The fluid delivery by the pulse generating unit 100 in this embodiment is achieved by the difference between inlet flow path side inertance L1 (referred to as synthetic inertance L1 as well) and outlet flow path side inertance L2 (referred to as synthetic inertance L2 as well).

Initially, the details of inertance are explained.

Inertance L is expressed as L=ρ×h/S (ρ: density of fluid, S: cross-sectional area of flow path, h: length of flow path). By transforming the equation of motion in the flow path by using the inertance L, the relation ΔP=L×dQ/dt is obtained (ΔP: pressure difference in flow path, Q: flow amount of fluid flowing in flow path).

Thus, the inertance L indicates effect level for flow amount change with time. The flow amount change with time decreases as the inertance L becomes larger, but increases as the inertance L becomes smaller.

In case of synthetic inertance in parallel connection of plural flow paths or in serial connection of plural flow paths having different shapes, synthetic inertance can be calculated by combining inertance of each flow path similarly to inductance in parallel connection or serial connection of electric circuit.

Since the diameter of the connection flow path 504 is sufficiently larger than that of the inlet flow path 503, only the inertance of the inlet flow path 503 needs to be calculated as the inertance L1 on the inlet flow path side. Since the connection tube for connecting the pump 20 and the inlet flow path and has flexibility, the inertance of the connection tube is excluded from the calculation of the inertance L1.

The diameter of the connection flow path 201 is considerably larger than that of the outlet flow path, and the pipe portion (pipe wall) of the connection flow pipe 200 has only a small effect on the inertance L2 on the outlet flow path side when the thickness of the pipe portion (pipe wall) of the connection flow pipe 200 is small. Thus, the inertance L2 on the outlet flow path side can be replaced with the inertance of the outlet flow path 511.

When the thickness of the pipe wall of the connection flow path pipe 200 is large, the inertance L2 becomes the synthesis inertance of the outlet flow path 511, the connection flow path 201, and the nozzle 211.

In this embodiment, the flow path length and the cross-sectional area of the inlet flow path 503 and the flow path length and the cross-sectional area of the outlet flow path 511 are determined such that the inertance L1 on the inlet flow path side becomes larger than the inertance L2 on the outlet flow path side.

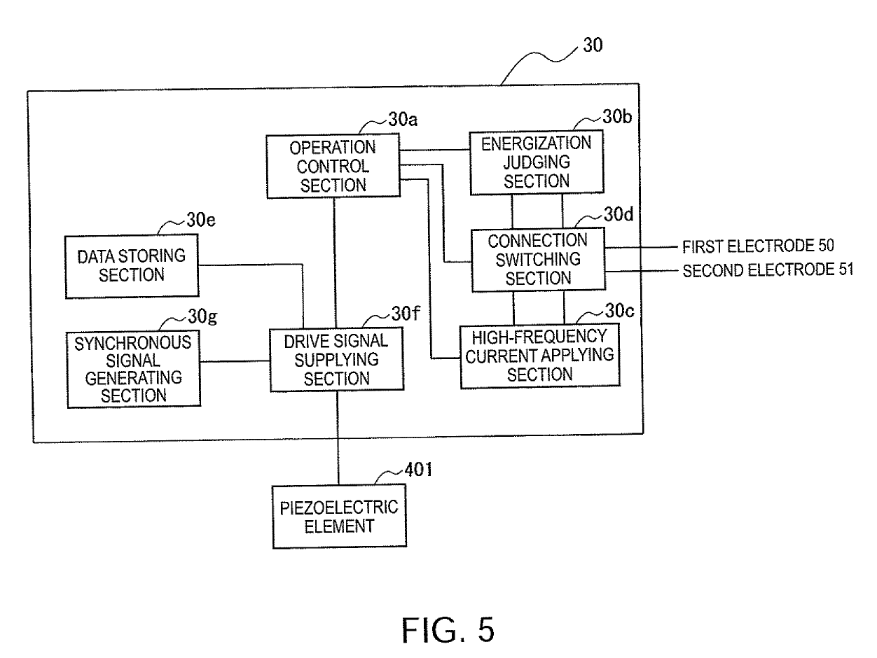

The detailed structure of the drive unit 30 is now described with reference to FIG. 5.

FIG. 5 is a block diagram showing the detailed structure of the drive unit 30.

As shown in FIG. 5, the drive unit 30 includes an operation control section 30a, an conduction judging section 30b, a high-frequency current applying section 30c, a connection switching section 30d, a data storing section 30e, a drive signal supplying section 30f, and a synchronous signal generating section 30g.

The operation control section 30a has function of issuing operation commands to the respective components in response to operation input given through an input unit (not shown) of the fluid ejection device 1. The operation control section 30a provides function of controlling various operation processes such as current applying process performed by the high-frequency current applying section 30c, switching process performed by the connection switching section 30d, and drive signal supplying process performed by the drive signal supplying section 30f.

More specifically, the operation control section 30a issues stop command for stopping supply of drive signals to the drive signal supplying section 30f when a drive switch (not shown) of a water pulse scalpel is switched from ON to OFF. By this step, supply of drive signals from the drive signal supplying section 30f stops.

When a drive switch (not shown) of an electric scalpel is turned on under the OFF condition of the drive switch of the water pulse scalpel, the operation control section 30a outputs a control signal to the connection switching section 30d such that the connections of the first electrode 50 and the second electrode 51 are switched from the conduction judging section 30b to the high-frequency current applying section 30c. When the first electrode 50 and the second electrode 51 are already connected with the high-frequency current applying section 30c, this step is not performed.

When the first and second electrodes 50 and 51 are connected with the high-frequency current applying section 30c, high-frequency current applying command is inputted to the high-frequency current applying section 30c. By this step, high-frequency current is applied between the first electrode 50 and the second electrode 51 from the high-frequency current applying section 30c. Then, arc is generated from the end of the nozzle 211 by bringing the nozzle 211 close to the human body to provide function of electric scalpel.

When the drive switch of the electric scalpel switched from ON to OFF, stop command is inputted to the high-frequency current applying section 30c. By this step, high-frequency current applied between the first electrode 50 and the second electrode 51 from the high-frequency current applying section 30c is stopped.

When the drive switch (not shown) of the water pulse scalpel is turned on under the OFF condition of the drive switch of the electric scalpel, a control signal for changing the connections of the first electrode 50 and the second electrode 51 from the high-frequency current applying section 30c to the conduction judging section 30b is inputted to the connection switching section 30d. When the first electrode 50 and the second electrode 51 are already connected with the conduction judging section 30b, this step is not performed.

When the first and second electrodes 50 and 51 are connected with the conduction judging section 30b, drive signal supply command or drive signal stop command is inputted to the drive signal supplying section 30f based on the judgment result of the enregization judging section 30b. By this step, the command signal corresponding to the judgment result of the conduction judging section 30b is inputted to the drive signal supplying section 30f.

The conduction judging section 30b includes a power source for outputting low voltage and current to be applied, and a load for conduction detection. The high voltage side terminal of the power source is electrically connected with the first electrode 50 via the connection switching section 30d, and the low voltage side terminal of the power source is electrically connected with the second electrode 51. The power source may be either direct current power source or alternating current power source.

The conduction judging section 30b judges conduction conditions of the first electrode and the second electrode by detecting current flowing in the load for conduction detection or voltage applied to the load to determine whether the first electrode 50 and the second electrode 51 are conducted based on the detection result. When judging that the first and second electrodes 50 and 51 are conducted, the conduction judging section 30b outputs a signal indicating conduction (such as high-level signal) to the operation control section 30a. When judging that the first and second electrodes 50 and 51 are not conducted, the conduction judging section 30b outputs a signal indicating no conduction (such as low-level signal) to the operation control section 30a.

The high-frequency current applying section 30c applies high-frequency current between the first electrode 50 and the second electrode 51 via the connection switching section 30d in response to an operation command from the operation control section 30a. By this step, the first electrode 50 becomes active electrode, while the second electrode 51 becomes feedback electrode. Then, arc is generated from the nozzle 211 constituting the first electrode 50 to provide function of electric scalpel.

The connection switching section 30d switches between the electric connection between the conduction judging section 30b and the first and second electrodes 50 and 51, and the electric connection between the high-frequency current applying section 30c and the first and second electrodes 50 and 51 based on control signals from the operation control section 30a.

The connection may be switched by using a mechanical switch or switching elements such as power transistors.

The data storing section 30e includes a storing medium for storing waveform information about plural types of signal waveforms corresponding to the set ejection intensity and having different cycles and amplitudes, data used for processes performed by the respective parts, and others. The data storing section 30e reads data stored in the storing medium in response to reading requests from the respective parts, and writes the data to the storing medium in response to writing requests from the respective parts.

The drive signal supplying section 30f supplies drive signals to the piezoelectric element 401 of the capacity changing unit 405 in synchronization with synchronous signals from the synchronous signal generating unit 30g in response to drive signal supply command issued from the operation control section 30a.

More specifically, the drive signal supplying section 30f reads corresponding waveform information (digital waveform data) from the data storing section 30e based on waveform specifying information contained in the supply command, produces analog drive signals converted from the digital waveform information read from the data storing section 30e, and supplies the drive signals thus produced to the piezoelectric element 401 in synchronization with the synchronous signals. The waveform specifying information is identification information or the like attached to the signal waveforms corresponding to the ejection intensity.

The drive signal supplying section 30f further has function of stopping supply of drive signals in response to the drive signal stop command from the operation control section 30a. When the stop command is inputted from the operation control section 30a during supply of drive signals in this embodiment, supply of the drive signals is stopped after supply of the final waveform in one cycle being supplied to the piezoelectric element 401.

The synchronous signal generating section 30g includes an oscillator such as ceramic oscillator and crystal oscillator, a counter (or PLL circuit) and other components, and produces synchronous signals based on reference clock signals clk outputted from the oscillator. The synchronous signal generating section 30g supplies the reference clock signals and synchronous signals to the drive signal supplying section 30f.

The drive unit 30 has a computer system which provides functions of the respective sections described above by software and executes the software for controlling hardware necessary for providing the functions. Though not shown in the figure, the hardware structure of this computer system includes a processor, a RAM (random access memory), and a ROM (read only memory) connected with one another via various internal and external buses.

Furthermore, display device such as CRT and LCD monitor, and input device such as operation panel, mouse, and keyboard are connected with the buses via input/output interface (I/F) such as IEEE1394, USB, and parallel port.

When power is supplied, various computer programs dedicated for providing the functions of the respective sections and stored in the ROM in advance are loaded into the RAM under the control of the system program stored in the ROM or the like. Then, predetermined controls and calculations are performed by the processor using various resources according to commands written in the programs loaded to the RAM to provide the respective functions.

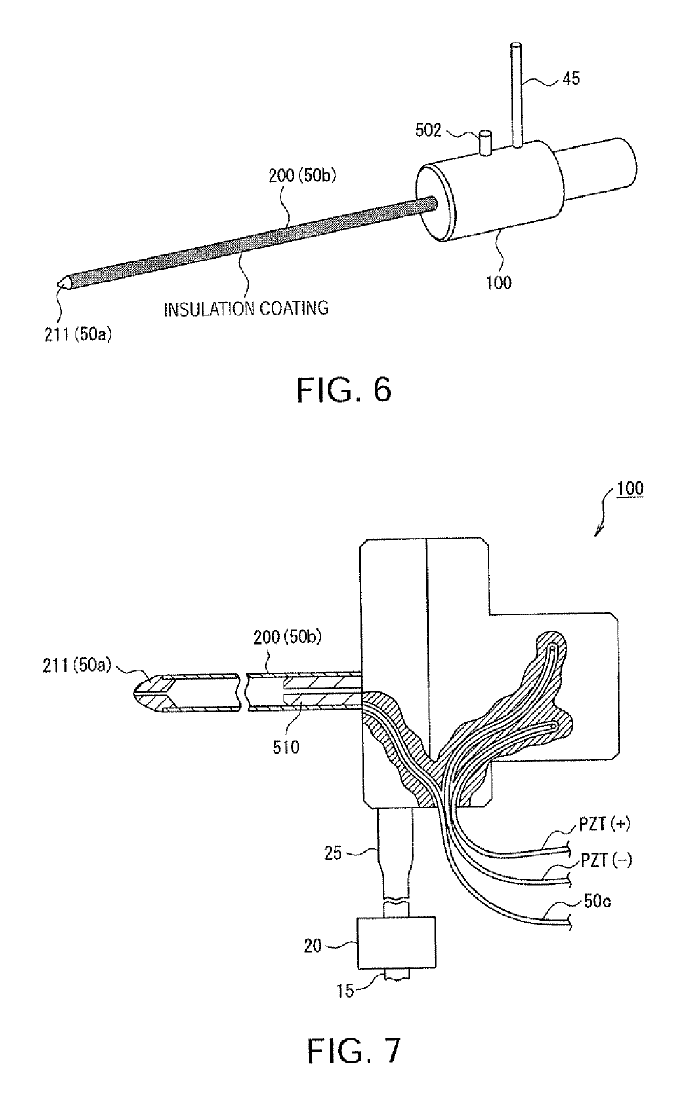

The detailed structure of the first electrode 50 is now discussed with reference to FIGS. 6 and 7.

FIG. 6 illustrates the structure of the first electrode 50, and FIG. 7 illustrates a wiring structure containing an electrode line and drive signal supply lines of the first electrode 50.

As illustrated in FIGS. 6 and 7, the first electrode 50 includes the nozzle 211 as a first contact portion 50a, the connection flow path pipe 200 as a conductive path 50b extending to the pulse generating unit 100, and an electrode line 50c provided inside the pulse generating unit 100.

The electrode line 50c is covered with insulation coating having heat resistance. One end of the electrode line 50c is electrically connected with the conductive path 50b, and the other end is electrically connected with a switch of the connection switching section 30d.

As illustrated in FIG. 7, the electrode line 50c extends through a passage formed inside the pulse generating unit 100. Similarly, a supply line PZT(+) connected with the higher voltage side of the piezoelectric element 401 and a supply line PZT(−) connected with the lower voltage side of the piezoelectric element 401 are covered with insulation coating having heat resistance, and extend through passages formed inside the pulse generating unit 100.

The wiring passages of the electrode line 50c and the supply lines PZT(+) and PZT(−) are joined in the vicinity of the exit as one unit of the cable 45.

As explained above, the nozzle 211 is made of conductive material, and the connection flow path pipe 200 is also made of conductive material. Thus, continuity can be produced between the first contact portion 50a, the conductive path 50b, and the electrode line 50c.

Thus, when the nozzle 211 (first contact portion 50a) is brought into contact with the ejection target portion of the human body or a conductor (such as liquid) contacting the ejection target portion with the second contact portion 51a of the second electrode 51 contacting the human body, the first electrode 50 and the second electrode 51 are conducted.

As discussed above, the outer periphery of the connection flow path 200 is covered with insulation coating, Thus, the first electrode and the second electrode are not conducted even when the outer periphery of the connection flow path pipe 200 contacts the ejection target portion of the human body or the conductor contacting the ejection target portion.

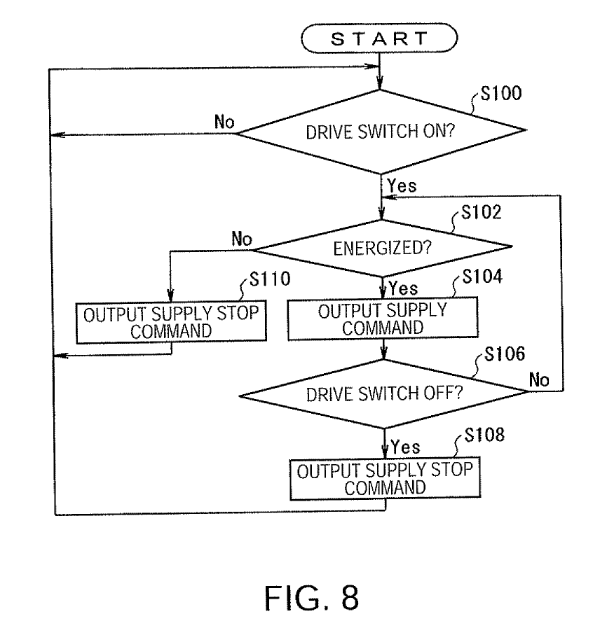

The flow of process for controlling operation of the drive signal supplying section 30f performed by the operation control section 30a is now described with reference to FIG. 8.

FIG. 8 is a flowchart showing the process for controlling operation of the drive signal supplying section 30f performed by the operation control section 30a. The flowchart in FIG. 8 shows the process performed when the first electrode 50 and the second electrode 51 are connected with the conduction judging section 30b under the OFF condition of the drive switch of the electric scalpel.

When the process for controlling the operation of the drive signal supplying section 30f under the dedicated program executed by the processor, the flow goes to step S100 as shown in FIG. 8.

In step S100, the operation control section 30a judges whether the drive switch of the water pulse scalpel (hereinafter abbreviated as WPS) is turned on. When it is determined that the drive switch is ON (YES), the flow goes to step S102. When it is determined that the drive switch is not ON (NO), the process is repeated until the drive switch is turned on.

When the flow goes to step S102, the operation control section 30a judges whether the first electrode 50 and the second electrode 51 are conducted based on the judgment signal from the conduction judging section 30b. When conducted condition (high-level judgment signal) (YES), the flow goes to step S104. When not conducted condition (NO), the flow goes to step S110.

That is, under the non-conducted condition of the first and second electrodes 50 and 51, drive signal supply command is not outputted to the drive signal supplying section 30f even when the drive switch is turned on.

When the flow goes to step S104, the operation control section 30a issues drive signal supply command to the drive signal supplying section 30f. Then, the flow goes to step S106.

In step S106, the operation control section 30a judges whether the drive switch is turned off. When it is determined that the drive switch is OFF (YES), the flow goes to step S118. When it is determined that the drive switch is not OFF (NO), the flow goes to step S102.

When the flow goes to step S108, the operation control section 30a outputs drive signal supply stop command to the drive signal supplying section 30f. Then, the flow goes to step S100.

When the flow shifts from step S102 to step S110 based on judgment of no conduction, the operation control section 30a issues supply stop command for stopping drive signal supply to the drive signal supplying section 30f. Then, the flow goes to step S100. When no drive signal is being supplied at the time of judgment of no conduction, the flow may proceed to step S100 without outputting supply stop command.

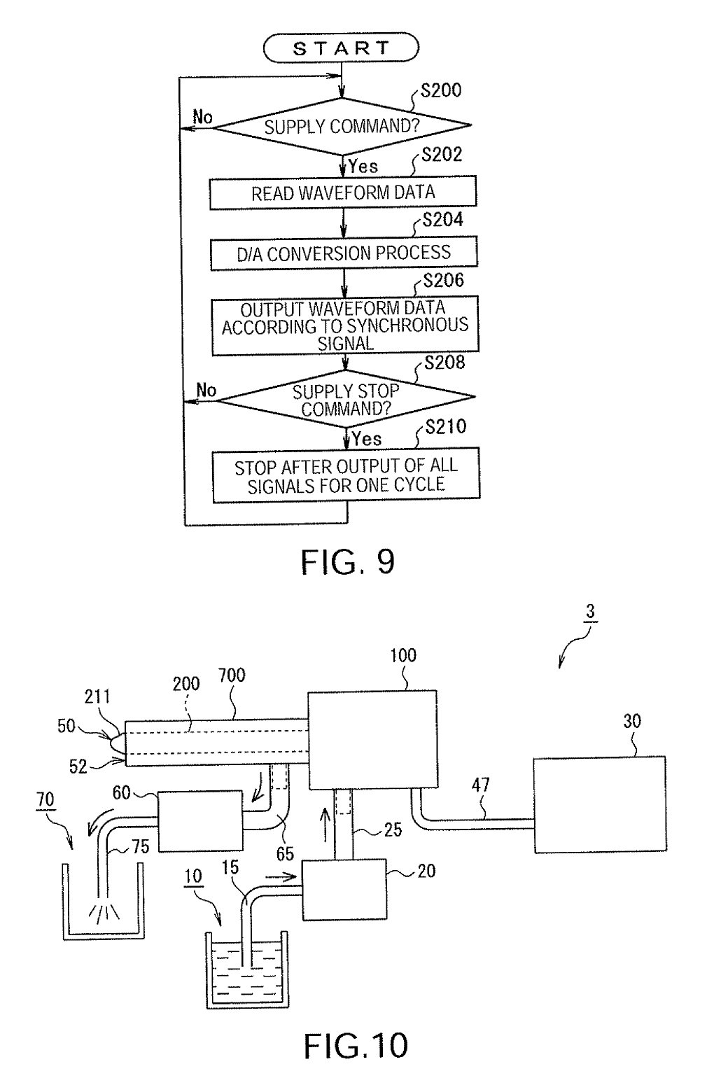

The flow of drive signal supply process performed by the drive signal supplying section 30f is now discussed with reference to FIG. 9.

FIG. 9 is a flowchart showing the drive signal supply process performed by the drive signal supplying section 30f.

When the drive signal supply process is initiated under the dedicated program executed by the processor, the flow goes to step S200 as shown in FIG. 9.

In step S200, the drive signal supplying section 30f judges whether drive command has been inputted from the operation control section 30a. When it is determined that the drive command has been inputted (YES), the flow goes to step S202. When it is determined that the drive command has not been inputted (NO), the judging process is repeated until the drive command is inputted.

When the flow goes to step S202, the drive signal supplying section 30f reads waveform data of the waveform type used for driving the piezoelectric element 401 from the data storing section 30e based on the identification information about the specifying waveform contained in the drive command. Then, the flow goes to step S204.

In step S204, the drive signal supplying section 30f converts digital waveform signals containing the waveform data read in step S202 into analog waveform signals. Then, the flow goes to step S206.

In step S206, the drive signal supplying section 30f outputs drive signals having analog signal waveforms obtained by the D/A conversion in step S204 to the piezoelectric element 401 in synchronization with the synchronous signals sent from the synchronous signal generating section 30g. Then, the flow goes to step S208.

In step S208, the drive signal supplying section 30f judges whether stop command has been inputted from the operation control section 30a. When it is determined that the command has been inputted (YES), the flow goes to step S210. When it is determined that the command has not been inputted (NO), the drive signal output process in step S204 is continued.

When the flow goes to step S210, the drive signal supplying section 30f stops supply of drive signals after outputting all signals for one cycle. Then, the flow goes to step S200.

The specific operation of the fluid ejection device 1 according to this embodiment is now described.

Initially, the second electrode 51 is attached to the arm or the like of the human body before starting operation of the fluid ejection device 1. Then, the initializing operation of the fluid ejection device 1 is executed by turning on the power source of the fluid ejection device 1. When it is detected that at least either the drive switch of the WPS or the drive switch of the electric scalpel has been turned on, the fluid ejection device 1 urges the user to turn off the switch by giving alarm from a not-shown speaker, displaying warning message on a display device, or lighting a not-shown lamp.

When both the drive switch of the WPS and the drive switch of the electric scalpel are turned off, the flow goes to drive standby condition after initialization. It is assumed that the first electrode 50 and the second electrode 51 are connected with the conduction judging section 30b.

When the drive switch of the WPS is turned on under this condition (“YES” branch in step S100), the operation control section 30a judges whether the first electrode 50 and the second electrode 51 are conducted based on the judgment signal from the conduction judging section 30b (step S102).

When the nozzle 211 does not contact the affected portion or the like in this step, the first and second electrodes 50 and 51 are not conducted (“NO” branch in step S102). Thus, the judgment process is repeated.

When the nozzle 211 is brought into contact with an object such as the affected portion or liquid surrounding the affected portion between which and the second electrode 51 continuity can be produced by the hand of the operator, the first electrode 50 and the second electrode 51 are conducted via the affected portion or the like. Then, the judgment signal (high level) indicating conduction is outputted from the conduction judging section 30b to the operation control section 30a. By this step, the operation control section 30a judges that the first electrode 50 and the second electrode 51 are conducted (“YES” branch in step S102), and outputs drive signal supply command to the drive signal supplying section 30f (step S104).

When the drive signal supplying section 30f receives the drive signal supply command (“YES” branch in step S200), the drive signal supplying section 30f reads and supplies the corresponding waveform information to the work memory such as the RAM from the data storing section 30e based on the identification information of the waveform information contained in the supply command (step S202).

Then, the drive signal supplying section 30f converts the digital waveform data read and supplied to the work memory into analog drive signals to produce analog drive signals (step S204).

Subsequently, the drive signal supplying section 30f outputs the produced analog drive signals to the piezoelectric element 401 in synchronization with the synchronous signals sent from the synchronous signal generating section 30g (step S206).

Before supply of the drive signals, fluid is supplied to the inlet flow path 503 with constant liquid pressure by the pump 20. Thus, when the piezoelectric element 401 does not operate, fluid flows into the fluid chamber 501 by the delivery force of the pump 20 and the difference between fluid resistances of the entire inlet flow path.

When the piezoelectric element 401 rapidly expands in response to input of the drive signal to the piezoelectric element 401, the pressure inside the fluid chamber 501 rapidly increases to several tens atm. under the condition that the inertance L1 and L2 on the inlet flow path side and outlet flow path side are sufficiently large.

This pressure is considerably higher than the pressure applied to the inlet flow path 503 by the pump 20. Thus, the flow amount of the fluid from the inlet flow path side into the fluid chamber 501 decreases, and the flow amount of the fluid discharged from the outlet flow path 511 increases due to the high pressure.

However, the inertance L1 of the inlet flow path 503 is larger than the inertance L2 of the outlet flow path 511. In this case, the decrease amount of the fluid flowing from the inlet flow path 503 into the fluid chamber 501 becomes larger than the increase amount of the fluid discharged from the outlet flow path. Thus, pulsed fluid delivery, that is, pulsed flow is produced in the connection flow path 201. The pressure change at the time of delivery is transmitted through the connection flow path pipe 200, and fluid is ejected from the fluid ejection opening 212 at the end of the nozzle 211.

The diameter of the fluid ejection opening 212 of the nozzle 211 is smaller than that of the outlet flow path 511. Thus, fluid is ejected as high-speed pulsed liquid drops.

The inside of the fluid chamber 501 is brought into vacuum condition immediately after pressure increase by interaction of the decrease in the fluid flow-in amount from the inlet flow path 503 and the increase in the fluid discharge amount from the outlet flow path 511.

Then, the expanded piezoelectric element 401 comes to contract at a speed corresponding to the falling shape of the drive waveform, and the flow of fluid finally returns to the steady condition before supply of the drive signals.

In this structure, the fluid chamber 501 has a substantially rotational body and the inlet flow path 503, and the outlet flow path 511 is formed in the vicinity of the rotation axis of the substantially rotational body of the fluid chamber 501. Thus, rotational flow is generated within the fluid chamber 501, and bubbles (vacuum bubbles and gas bubbles) contained in the fluid are rapidly discharged from the outlet flow path 511 to the outside.

The pulsed flow can be continuously ejected from the nozzle 211 by successively supplying drive signals to the piezoelectric element 401.

When the operator moves the pulse generating unit 100 and separates the nozzle 211 from the affected portion or liquid around the affected portion under the condition in which pulsed flow is continuously ejected in response to successive supply of drive signals, a judgment signal (low level) indicating no conduction is outputted from the conduction judging section 30b to the operation control section 30a.

Based on this signal, the operation control section 30a judges that the first electrode 50 and the second electrode 51 are not conducted (“NO” branch in step S102), and issues supply stop command to the drive signal supplying section 30f (step S110).

When receiving the supply stop command from the operation control section 30a (“YES” branch in step S208), the drive signal supplying section 30f stops supply of drive signals after completing supply of all drive signals currently supplied for one cycle (step S210).

When the nozzle 211 again contacts the affected portion or liquid around the affected portion with the drive switch of the WPS turned on, the first electrode 50 and the second electrode 51 are conducted (“YES” branch in step S102). Then, drive signal supply command is outputted to the drive signal supplying section 30f. By this step, drive signals are supplied to the piezoelectric element 401 to restart ejection of pulsed flow.

When the drive switch of the WPS is turned off by the operator under this condition, the operation control section 30a judges that the drive switch is turned off (“YES” branch in step S106), and outputs supply stop command to the drive signal supplying section 30f (step S108)

By this step, the drive signal supplying section 30f stops supply of drive signals after completing supply of all drive signals currently supplied for one cycle (step S210). When supply of drive signals stops, ejection of pulse flow stops accordingly.

When the drive switch of the electric scalpel is turned on under the OFF condition of the drive switch of the WPS, the operation control section 30a outputs a control signal to the connection switching section 30d for changing the connections of the first and second electrodes 50 and 51 from the conduction judging section 30b to the high-frequency current applying section 30c.

By this step, connections of the first electrode 50 and the second electrode 51 are switched to the high-frequency current applying section 30c.

After the first and second electrodes 50 and 51 are connected with the high-frequency current applying section 30c, the operation control section 30a outputs high-frequency current applying command to the high frequency current applying section 30c. By this step, the high-frequency current applying section 30c applies high-frequency current between the first electrode 50 and the second electrode 51.

In this condition, arc is produced from the end of the nozzle 211 by bringing the nozzle 211 close to the affected portion of the human body to which the second electrode has been attached. By this method, the fluid ejection device 1 functions as electric scalpel capable of removing the affected portion, coagulating tissue for hemostasis and other processing.

Accordingly, the fluid ejection device 1 in this embodiment controls the operations of the drive signal supplying section 30f and the capacity changing unit 405 such that fluid can be ejected when the drive switch of the WPS is turned on under the conducted condition of the first and second electrodes 50 and 51. On the other hand, under the condition of no conduction of the first and second electrodes 50 and 51, the fluid ejection device 1 controls the operations of the drive signal supplying section 30f and the capacity changing unit 405 such that fluid is not ejected even when the drive switch of the WPS is turned on.

Moreover, the fluid ejection device 1 controls the operations of the drive signal supplying section 30f and the capacity changing unit 405 such that fluid ejection is stopped when the first electrode 50 and the second electrode 51 are not conducted during ejection of fluid.

By this method, ejection operation is stopped while the first and second electrodes 50 and 51 are not conducted. Thus, high-pressure ejection of pulsed flow in an unexpected direction (such as a direction toward a person in the operation room or a portion not to be removed, or scattering of tissue pieces cut by ejection in an unexpected direction or position can be prevented when the nozzle 211 is separated from the affected portion or liquid around the affected portion.

The fluid ejection device 1 according to this embodiment has the nozzle 211 and the connection flow path pipe 200 made of conductive material, and the first electrode 50 constituted by the nozzle 211, the connection flow path pipe 200, and the electrode line Sc. Since the first electrode 50 is constituted by the components originally included in the fluid ejection device 1, the first electrode 50 can be produced at lower cost than that of a structure including the first electrode 50 equipped separately from those components.

Moreover, the fluid ejection device 1 in this embodiment can generate arc at the end of the nozzle 211 by applying high-frequency current between the first electrode 50 and the second electrode 51 using the high-frequency current applying section 30c to function as electric scalpel.

In the first embodiment, the nozzle 211 and the fluid ejection opening 212 correspond to a fluid ejection opening as referred to in any of the first, third, tenth and fourteenth aspects. The capacity changing unit 405 and the drive signal supplying section 30f correspond to a capacity changing unit as referred to in any of the first, thirteenth and fourteenth aspects. The fluid container 10 and the pump 20 correspond to a fluid supplying unit as referred to in any of the first, twelfth and fourteenth aspects. The operation control section 30a corresponds to an operation control unit as referred to in any of the first, thirteenth and fourteenth aspects. The conduction judging section 30b corresponds to an conduction judging unit as referred to in any of the first, eighth, thirteenth and fourteenth aspects. The high-frequency current applying section 30c corresponds to a high-frequency current applying unit as referred to in the eighth aspect. The connection switching section 30d corresponds to a switching unit as referred to in the eighth aspects.

### Second Embodiment

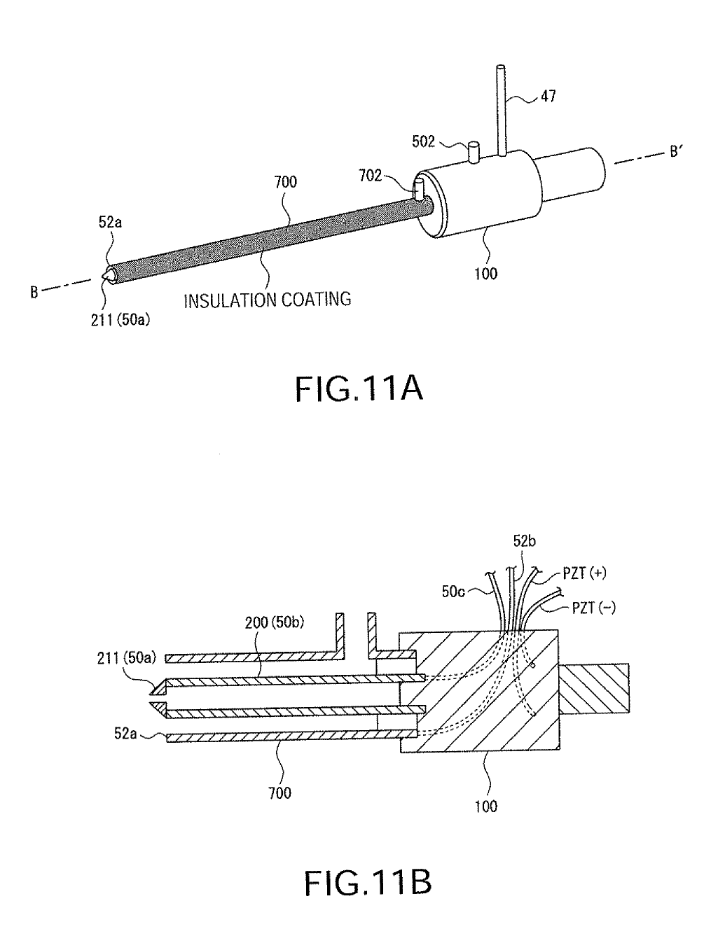

A second embodiment according to the invention is hereinafter described with reference to the drawings. FIGS. 10 and 11 show a fluid ejection device, a driving method of a fluid ejection device, and an operating instrument according to the second embodiment of the invention.

The second embodiment is different from the first embodiment in that components such as suction pipe and pump disposed in such positions as to cover the connection flow path pipe 200 are equipped to suck an object close to the nozzle 211, and that a second contact portion constituting a second electrode is provided at the opening of the suction pipe. Other parts are similar to those of the first embodiment. Thus, in the following description, only the different parts are discussed in detail, and explanation of the similar parts is not repeated.

The structure of the fluid ejection device according to this embodiment is now described with reference to FIG. 10. FIG. 10 illustrates a general structure of a fluid ejection device 3 according to this embodiment.

As illustrated in FIG. 10, the fluid ejection device 3 has a basic structure including the fluid container 10 for storing fluid, the pump 20 as a pressure generating unit, a suction container 70 for storing sucked object, a suction pump 60 as sucking force giving unit, the pulse generating unit 100 for generating pulsed flow of fluid supplied from the pump 20, the drive unit 30 for driving the pulse generating unit 100, the first electrode 50, and a second electrode 52.

The pulse generating unit 100 is connected with the connection fluid path pipe 200 having narrow pipe shape. The nozzle 211 having a diameter smaller than the flow path diameter of the connection flow path pipe 200 is inserted into the end of the connection flow path pipe 200.

A pipe-shaped suction pipe 700 having a diameter larger than that of the connection flow path pipe 200 and containing the connection flow path pipe 200 is connected with the pulse generating unit 100.

A passage through which sucked object such as delivered liquid and tissue pieces passes is formed between the inner circumferential surface of the suction pipe 700 and an outer circumferential surface of the connection flow path pipe 200 having a different diameter from that of the suction pipe 700.

An outlet flow path pipe 702 through which the sucked object is supplied to the suction container 70 projects from the suction pipe 700 on the pulse generating unit 100 side. The sucked object is attracted by the suction pump 60 via a connection tube 65 connected with the outlet flow path pipe 702, and discharged toward the suction container 70 via a connection tube 75.

The connection flow path pipe 200 and the suction pipe 700 are made of conductive material. The outer circumference of the suction pipe 700 other than its end (arbitrary area including opening end) is coated with insulator.

The nozzle 211 is made of conductive material, and functions as the first contact portion of the first electrode 50 as positive electrode. Continuity is produced between the nozzle 211 and the connection flow path pipe 200 via the insertion portion.

The end of the suction pipe 700 (portion not coated with insulator) functions as a second contact portion of the second electrode 52 as negative electrode. The detailed structure of the second electrode 52 will be described later.

A cable 47 including the electrode line 50c and the electrode line 52b extends from the pulse generating unit 100. Continuity is produced between the electrode line 50c and the nozzle 211 as the first contact portion of the first electrode 50 via the connection flow path pipe 200. Continuity is produced between the electrode line 52b and the suction pipe 700 having the second contact portion of the second electrode at the end. The cable 47 further has the supply lines PZT(+) and the PZT(−) for supplying drive signals to the capacity changing unit 405. The respective lines of the cable 47 are electrically connected with the corresponding components of the drive unit 30.

The detailed structures of the first electrode 50 and the second electrode 52 are now discussed with reference to FIGS. 11A and 11B.

FIG. 11A illustrates the structures of the first electrode 50 and the second electrode 52, and FIG. 11B is a cross-sectional view taken along a line B-B′ in FIG. 11A.

As illustrated in FIGS. 11A and 11B, the first electrode 50 includes the nozzle 211 as the first contact portion 50a, the connection flow path pipe 200 as the conductive path 50b extending to the pulse generating unit 100, and the electrode line 50c provided inside the pulse generating unit 100.

The end of the second electrode 52 is the second contact portion 52a, and the main body of the second electrode 52 includes the suction pipe 700 as conductive path extending to the pulse generating unit 100 and the electrode line 52b provided inside the pulse generating unit 100.

The electrode line 50c is covered with insulation coating having heat resistance. One end of the electrode line 50c is electrically connected with the conductive path 50b, and the other end is electrically connected with the switch of the connection switching section 30d.

The electrode line 52b is covered with insulation coating having heat resistance. One end of the electrode line 50c is electrically connected with the suction pipe 700, and the other end is electrically connected with the switch of the connection switching section 30d.

The electrode lines 50c and 52b extend through passages (not shown) formed inside the pulse generating unit 100. Similarly, the supply line PZT(+) connected with the higher voltage side of the piezoelectric element 401 and the supply line PZT(−) connected with the lower voltage side of the piezoelectric element 401 are covered with insulation coating having heat resistance, and extend through passages (not shown) formed inside the pulse generating unit 100.

The wiring passages of the electrode line 50c, the electrode line 52b, and the supply lines PZT(+) and PZT(−) are joined in the vicinity of the exit as one unit of the cable 47.

As discussed, the nozzle 211 is made of conductive material, and the connection flow path pipe 200 is also made of conductive material. Thus, continuity is produced between the first contact portion 50a, the conductive path 50b, and the electrode line 50c.

Similarly, the suction pipe 700 is made of conductive material. Thus, continuity is produced between the second contact portion 52a and the electrode line 52b.

When both the nozzle 211 (first contact portion 50a) and the end of the suction pipe 700 (second contact portion 52a) are brought into contact with the ejection target portion (affected portion) of the human body or conductor (liquid) contacting the affected portion in this structure, the first electrode 50 and the second electrode 52 are conducted.

When the first electrode 50 and the second electrode 52 are conducted, the judgment signal of the conduction judging section 30b becomes high level. Thus, the operation control section 30a outputs drive signal supply command to the drive signal supplying section 30f when the drive switch of the WPS is turned on.

By this step, the piezoelectric element 401 of the capacity changing unit 405 operates to perform ejection of high-pressure fluid (pulsed flow).

When the nozzle 211 (first contact portion 50a) and the end of the suction pipe 700 (second contact portion 52a) are separated from the ejection target portion (affected portion) of the human body or conductor (liquid) contacting the affected portion in this structure, the first electrode 50 and the second electrode 52 are not conducted.

When the first electrode 50 and the second electrode 52 are not conducted, the judgment signal of the conduction judging section 30b becomes low level. In this condition, the operation control section 30a does not output drive signal supply command to the drive signal supplying section 30f even when the drive switch of the WPS is turned on. When the drive switch is in ON condition in this step, the operation control section 30a outputs drive signal supply stop command to the drive signal supplying section 30f.

The fluid ejection device 3 according to this embodiment controls operations of the drive signal supplying section 30f and the capacity changing unit 405 such that ejection of fluid can be performed when the drive switch of the WPS is turned on with the first and second electrodes 50 and 52 conducted. However, in the condition that the first and second electrodes 50 and 52 are not conducted, the drive signal supplying section 30f and the capacity changing section 405 are controlled such that ejection of fluid is not performed even when the drive switch of the WPS is turned on.

Moreover, the fluid ejection device 3 controls the operations of the drive signal supplying section 30f and the capacity changing unit 405 such that fluid ejection is stopped when conduction of the first electrode 50 and the second electrode 52 is suspended during ejection of fluid.

By this method, ejection operation is stopped while the first and second electrodes 50 and 52 are not conducted. Thus, high-pressure ejection of pulsed flow in an unexpected direction (such as a direction toward a person in the operation room or a portion not to be removed), or scattering of tissue pieces cut by ejection in an unexpected direction or position can be prevented when the nozzle 211 is separated from the affected portion or liquid around the affected portion.

The fluid ejection device 3 according to this embodiment has the nozzle 211, the connection flow path pipe 200, the suction pipe 700 made of conductive material, the first electrode 50 constituted by the nozzle 211, the connection flow path pipe 200, and the electrode line 50c, and the second electrode 52 constituted by the suction pipe 700 and the electrode line 52b. Since the first and second electrodes 50 and 52 are constituted by the components originally included in the fluid ejection device 3, the first and second electrodes 50 and 52 can be provided at lower cost than that of a structure including the first and second electrodes 50 and 52 equipped separately from those components.

In the second embodiment, the nozzle 211 and the fluid ejection opening 212 correspond to a fluid ejection opening as referred to in any of the first, third, fifth, ninth, tenth and fourteenth aspects. The capacity changing unit 405 and the drive signal supplying section 30f correspond to a capacity changing unit as referred to in any of the first, thirteenth and fourteenth aspects. The fluid container 10 and the pump 20 correspond to a fluid supplying unit as referred to in any of the first, twelfth and fourteenth aspects. The suction container 70 and the pump 60 correspond to a sucking force giving unit as referred to in the ninth aspect. The operation control section 30a corresponds to an operation control unit as referred to in any of the first, thirteenth and fourteenth aspects. The conduction judging section 30b corresponds to an conduction judging unit as referred to in any of the first, eighth, thirteenth and fourteenth aspects. The high-frequency current applying section 30c corresponds to a high-frequency current applying unit as referred to in the eighth aspect. The connection switching section 30d corresponds to a switching unit as referred to in the eighth aspect.

### Modified Example of Second Embodiment

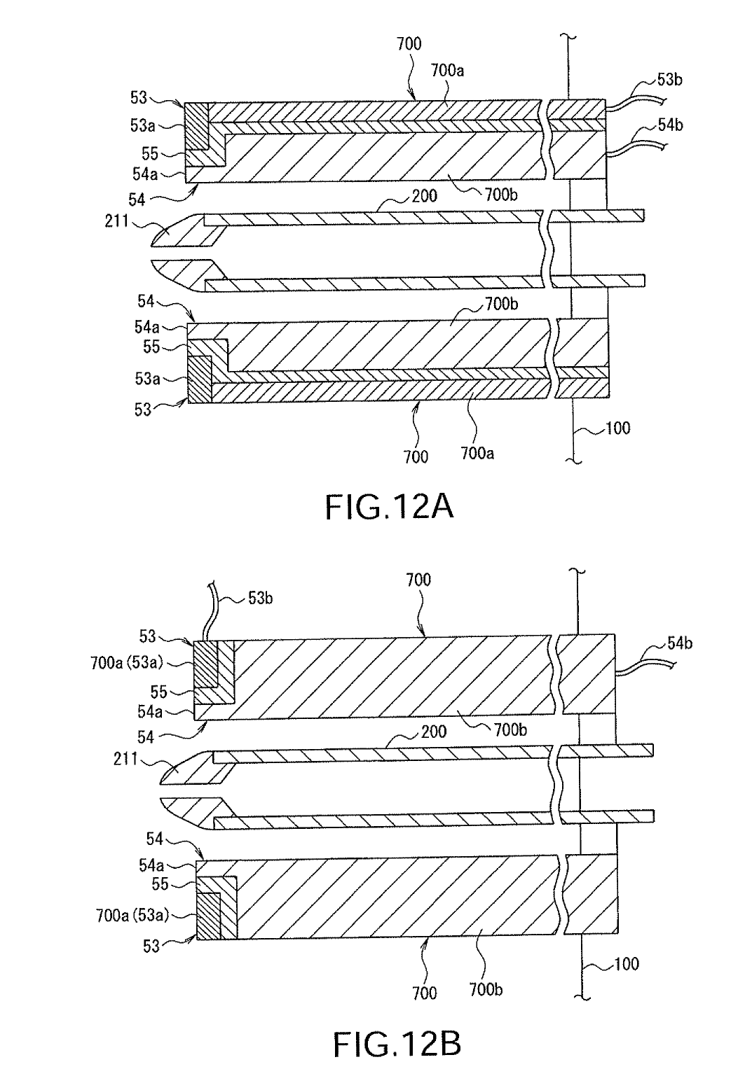

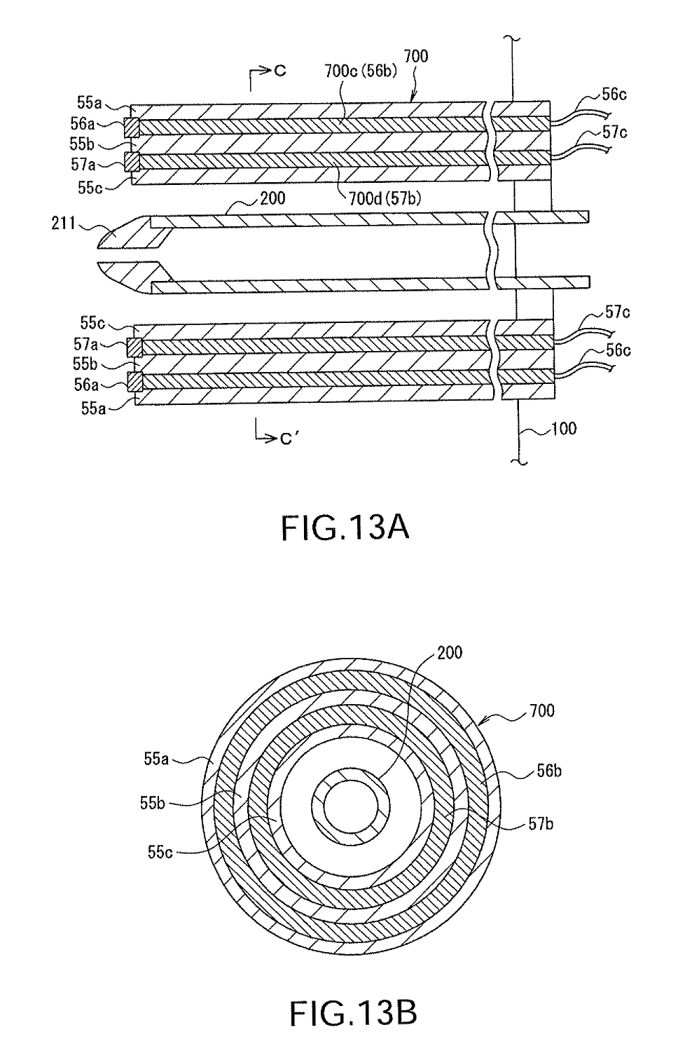

A modified example of the second embodiment according to the invention is now described with reference to the drawings. FIGS. 12A and 12B and FIGS. 13A and 13B illustrate modified examples of the fluid ejection device, the driving method of the fluid ejection device, and the operating instrument in the second embodiment.

This modified example is different from the second embodiment in that the first contact portion of the first electrode and the second contact portion of the second electrode are provided on the suction pipe 700. Other parts are similar to those of the second embodiment. Thus, in the following description, only the different parts are discussed in detail, and explanation of the similar parts is not repeated.

Initially, first and second structures of the first electrode and the second electrode according to this modified example are explained with reference to FIGS. 12A and 12B. FIG. 12A is a cross-sectional view of the nozzle 211, the connection flow path pipe 200, and the suction pipe 700 for explaining the first structure of the first electrode and the second electrode. FIG. 12B is a cross-sectional view of the nozzle 211, the connection flow path pipe 200, and the suction pipe 700 for explaining the second structure of the first electrode and the second electrode.

The first structure of the first electrode and the second electrode according to this modified example is now discussed with reference to FIG. 12A.

As illustrated in FIG. 12A, a first electrode 53 as positive electrode has a first contact portion 53a formed at the end of the suction pipe 700 made of conductive material, and an electrode line 53b provided inside the pulse generating unit 100 and electrically connected with the rear end of the suction pipe 700.

A second electrode 54 as negative electrode has a second contact portion 54a formed at the end of the suction pipe 700, and an electrode line 54b provided inside the pulse generating unit 100 and electrically connected with the rear end of the suction pipe 700.

The suction pipe 700 includes a first pipe wall 700a as a conductive path of the first electrode 53, a second pipe wall 700b as a conductive path of the second electrode 54, and a cylindrical insulator 55. The first pipe wall 700a and the second pipe wall 700b are insulated from each other by the insulator 55.

The electrode line 53b is covered by insulation coating having heat resistance. One end of the electrode line 53b is electrically connected with the first pipe wall 700a, and the other end is electrically connected with the switch of the connection switching section 30d. Thus, continuity is produced between the first contact portion 53a and the electrode line 53b.

The electrode line 54b is covered by insulation coating having heat resistance. One end of the electrode line 54b is electrically connected with the second pipe wall 700b, and the other end is electrically connected with the switch of the connection switching section 30d. Thus, continuity is produced between the second contact portion 54a and the electrode line 54b.

The electrode lines 53b and 54h extend through passages (not shown) formed inside the pulse generating unit 100. Similarly, the supply line PZT(+) connected with the higher voltage side of the piezoelectric element 401 and the supply line PZT(−) connected with the lower voltage side of the piezoelectric element 401 are covered with insulation coating having heat resistance, and extend through passages (not shown) formed inside the pulse generating unit 100.

The cable 47 containing the electrode line 53b, the electrode line 54b, and the supply lines PZT(+) and PZT(−) extends from the pulse generating unit 100. The respective lines of the cable 47 are electrically connected with the components of the drive unit 30.

The second structure of the first electrode and the second electrode is now discussed with reference to FIG. 12B.

As illustrated in FIG. 12B, the first electrode 53 as positive electrode has the first contact portion 53a formed at the end of the suction pipe 700 made of conductive material, and the electrode line 53b electrically connected with the first contact portion 53a.

The second electrode 54 as negative electrode has the second contact portion 54a formed at the end of the suction pipe 700, and the electrode line 54b provided inside the pulse generating unit 100 and electrically connected with the rear end of the suction pipe 700.

The suction pipe 700 includes the first pipe wall 700a as the first contact portion 53a of the first electrode 53, the second pipe wall 70b as the conductive path of the second electrode 54, and the cylindrical insulator 55. The first pipe wall 700a and the second pipe wall 700b are insulated from each other by the insulator 55.

The electrode line 53b is covered by insulation coating having heat resistance. One end of the electrode line 53b is electrically connected with the first contact portion 53a, and the other end is electrically connected with the switch of the connection switching section 30d. Thus, continuity is produced between the first contact portion 53a and the electrode line 53b.

The electrode line 54b is covered by insulation coating having heat resistance. One end of the electrode line 54b is electrically connected with the second pipe wall 700b, and the other end is electrically connected with the switch of the connection switching section 30d. Thus, continuity is produced between the second contact portion 54a and the electrode line 54b.

The electrode line 54b is provided in a passage (not shown) formed inside the pulse generating unit 100. The cable 47 containing the electrode line 54b and the supply lines PZT (+) and PZT(−) extends from the pulse generating unit 100. The respective lines of the cable 47 are electrically connected with the components of the drive unit 30.

The electrode line 53b is fixed to the outer circumference of the suction pipe 700 or provided in other way so as not to become an obstacle during operation.

When both the first contact portion 53a and the second contact portion 54a formed at the end of the suction pipe 700 are brought into contact with the ejection target portion (affected portion) of the human body or the conductor (such as liquid) in the first and second structures, the first electrode 53 and the second electrode 54 are conducted.

When the first electrode 53 and the second electrode 54 are conducted, the judgment signal of the conduction judging section 30b becomes high level. In this condition, the operation control section 30a outputs drive signal supply command to the drive signal supplying section 30f when the drive switch of the WPS is turned on.

By this step, the piezoelectric element 401 of the capacity changing unit 405 operates to perform ejection of high-pressure fluid (pulsed flow).

When at least either the first contact portion 53a or the second contact portion 54a is separated from the ejection target portion (affected portion) of the human body or conductor (liquid) contacting the affected portion, the first electrode 53 and the second electrode 54 are not conducted.

When the first electrode 53 and the second electrode 54 are not conducted, the judgment signal of the conduction judging section 30b becomes low level. In this condition, the operation control section 30a does not output drive signal supply command to the drive signal supplying section 30f even when the drive switch of the WPS is turned on. When the drive switch is in ON condition in this step, the operation control section 30a outputs drive signal supply stop command to the drive signal supplying section 30f.

A third structure of the first electrode and the second electrode according to this modified example is now discussed with reference to FIGS. 13A and 13B. FIG. 13A is a cross-sectional view of the third structure of the first electrode and the second electrode in this modified example. FIG. 13B is a cross-sectional view illustrating the nozzle 211, the connection flow path pipe 200, and the suction pipe 700 included in the fluid ejection device 3 taken along a line C-C′ in FIG. 13A.

As illustrated in FIGS. 13A and 13B, the suction pipe 700 includes cylindrical first, second, and third insulation pipe walls 55a, 55b, and 55c made of an insulating material and having different radii, a cylindrical first conductive pipe wall 700c made of conductor formed between the first and second insulation pipe walls 55a and 55b and concentric therewith (radius of 55a>radius of 700c>radius of 55b), and a cylindrical second conductive pipe wall 700d made of conductor formed between the second and third insulation pipe walls 55b and 55c and concentric therewith (radius of 55b>radius of 700d>radius of 55c).

That is, a radius R1 of the first insulation pipe wall 55a, a radius R2 of the second insulation pipe wall 55b, a radius R3 of the third insulation pipe wall 55c, a radius R4 of the first conductive pipe wall 700c, and a radius R5 of the second conductive pipe wall 700d have relationship of “R1>R4>R2>R5A>R3”.

The first electrode 56 as positive electrode has a first contact portion 56a formed at the front end of the first conductive pipe wall 700c constituting the suction pipe 700, a conductive path 56b constituted by the main body of the first conductive pipe wall 700c, and an electrode line 56c provided inside the pulse generating unit 100 and electrically connected with the rear end of the first conductive pipe wall 700c.

The second electrode 57 as negative electrode has a second contact portion 57a formed at the front end of the second conductive pipe wall 700d constituting the suction pipe 700, a conductive path 57b constituted by the main body of the second conductive pipe wall 700d, and an electrode line 57c provided inside the pulse generating unit 100 and electrically connected with the rear end of second conductive pipe wall 700d.

The electrode line 56c is covered with insulation coating having heat resistance. One end of the electrode line 56c is electrically connected with the first conductive pipe wall 700c, and the other end is electrically connected with the switch of the connection switching section 30d. Thus, continuity is produced between the first contact portion 56a and the electrode line 56c via the conductive path 56b.

The electrode line 57c is covered with insulation coating having heat resistance. One end of the electrode line 57c is electrically connected with the second conductive pipe wall 700d, and the other end is electrically connected with the switch of the connection switching section 30d. Thus, continuity is produced between the second contact portion 57a and the electrode line 57c via the conductive path 57b.

The electrode lines 56c and 57c extend through passages (not shown) formed inside the pulse generating unit 100. The cable 47 having the electrode line 56c, the electrode line 57c, and the supply lines PZT(+) and the PZT(−) extends from the pulse generating unit 100. The respective lines of the cable 47 are electrically connected with the corresponding components of the drive unit 30.

When both the first contact portion 56a formed at the end of the first conductive pipe wall 700c and the second contact portion 57a formed at the end of the second conductive pipe wall 700d in the third structure are brought into contact with the ejection target portion (affected portion) of the human body or a conductor (such as liquid) contacting the ejection target portion, the first electrode 56 and the second electrode 57 are conducted.

When the first electrode 56 and the second electrode 57 are conducted, the judgment signal of the conduction judging section 30b becomes high level. In this condition, the operation control section 30a outputs drive signal supply command to the drive signal supplying section 30f when the drive switch of the WPS is turned on.

By this step, the piezoelectric element 401 of the capacity changing unit 405 operates to perform ejection of high-pressure fluid (pulsed flow).

When at least either the first contact portion 56a or the second contact portion 57a is separated from the ejection target portion (affected portion) of the human body or conductor (such as liquid) contacting the affected portion, the first electrode 56 and the second electrode 57 are not conducted.

When the first electrode 56 and the second electrode 57 are not conducted, the judgment signal of the conduction judging section 30b becomes low level. In this condition, the operation control section 30a does not output drive signal supply command to the drive signal supplying section 30f even when the drive switch of the WPS is turned on. When the drive switch is in ON condition in this step, the operation control section 30a outputs drive signal supply stop command to the drive signal supplying section 30f.

The fluid ejection device 3 according to the first through third structures of this modified example controls operations of the drive signal supplying section 30f and the capacity changing unit 405 such that ejection of fluid can be performed when the drive switch of the WPS is turned on with the first and second electrodes 53 and 54 (or the first and the second electrodes 56 and 57) conducted In the condition where the first and second electrodes 53 and 54 (or first and second electrodes 56 and 57) are not conducted, however, the drive signal supplying section 30f and the capacity changing section 405 are controlled such that ejection of fluid is not performed even when the drive switch of the WPS is turned on.

Moreover, the fluid ejection device 3 controls the operations of the drive signal supplying section 30f and the capacity changing unit 405 such that fluid ejection is stopped when conduction of the first electrode 53 and the second electrode 54 (or first electrode 56 and the second electrode 57) is suspended during ejection of fluid.

By this method, ejection operation is stopped while the first and second electrodes 53 and 54 (or first and second electrodes 56 and 57) are not conducted. Thus, high-pressure ejection of pulsed flow in an unexpected direction (such as a direction toward a person in the operation room or a portion not to be removed), or scattering of tissue pieces cut by ejection in an unexpected direction or position can be prevented when the end of the suction pipe 700 (and the nozzle 211) is separated from the affected portion or liquid around the affected portion.

The first through third structures according to this modified example has the first contacting portion 53a (or 56a) of the first electrode 53 (or 56) and the second contact portion 54a (or 57a) of the second electrode 54 (or 57) both disposed on the suction pipe 700. Thus, the nozzle 211 and the connection flow path pipe 200 of the types used in related art can be used.

According to the first and second embodiments and the modified example, the fluid ejection device 1 or 3 functions as electric scalpel by using the high-frequency current applying section 30c and the connection switching section 30d. However, the fluid ejection device 1 or 3 may function only as water pulse scalpel. In this case, the high-frequency current applying section 30c and the connection switching section 30d can be eliminated.

According to the first and second embodiments and the modified example, the first electrode is positive electrode, and the second electrode is negative electrode. However, the polarities of these electrodes may be reversed.

According to the first embodiment, the first contact portion 50a of the first electrode 50 is constituted by the nozzle 211, and the second contact portion 51a of the second electrode 51 is attached to the ejection target object of the human body or the like. However, the first contact portion 50a and the second contact portion 51a may be provided on the nozzle 211 and the connection flow path pipe 200.

The first and second embodiments and the modified example are preferred examples of the invention, and thus various preferred limitations are given in technical views. It is intended, however, that the scope of the invention is not limited to those examples as long as description limiting the scope of the invention is not particularly shown. The figures referred to in this description are only schematic drawings containing vertical and horizontal reduction scales different from actual scales of the components and parts.

The invention is not limited to the first and second embodiments and the modified example described herein. Modifications, improvements and the like of the embodiments and example without departing from the scope of the invention are included in the appended claims.

What is claimed is:

1. A fluid ejection device comprising:
a fluid chamber whose capacity is variable;
an inlet flow path and an outlet flow path communicating with the fluid chamber;
a capacity changing unit which changes the capacity of the fluid chamber;
a fluid supplying unit which supplies fluid to the inlet flow path;
a fluid ejection opening disposed at an end of the outlet flow path opposite to an end communicating with the fluid chamber;
a first electrode of a predetermined polarity having a first contact portion disposed at the fluid ejection opening or a component in the vicinity of the fluid ejection opening;
a second electrode having a polarity different from the predetermined polarity and having a second conductive contact portion;
a conduction judging unit which judges whether the first electrode and the second electrode are conducted; and
an operation control unit which controls operation of the capacity changing unit based on judgment result of the conduction judging unit.

2. The fluid ejection device according to claim 1, wherein the second electrode has an attachment member which attaches the second contact portion of the second electrode such that the second contact portion contacts an ejection target object for the fluid.

3. The fluid ejection device according to claim 1, wherein the fluid ejection opening or the component in the vicinity of the fluid ejection opening is made of conductive material and forms the first contact portion of the first electrode.

4. The fluid ejection device according to claim 1, wherein the first electrode is disposed at the fluid ejection opening, and the second electrode is disposed on the component in the vicinity of the fluid ejection opening.

5. The fluid ejection device according to claim 4, wherein:
the fluid ejection opening and the component in the vicinity of the fluid ejection opening are made of conductive material;
the fluid ejection opening forms the first contact portion of the first electrode; and
the component in the vicinity of the fluid ejection opening forms the second contact portion of the second electrode.

6. The fluid ejection device according to claim 1, wherein the first contact portion and the second contact portion are provided on the component in the vicinity of the fluid ejection opening.

7. The fluid ejection device according to claim 6, wherein:
the component in the vicinity of the fluid ejection opening is made of conductive material; and
the first contact portion and the second contact portion are disposed on the component in the vicinity of the fluid ejection opening via an insulator such that the first electrode and the second electrode are not conducted when the first contact portion and the second contact portion do not contact the ejection target object.

8. The fluid ejection device according to claim 11 further comprising:
a high-frequency current applying unit which applies high-frequency current between the first electrode and the second electrode; and
a switching unit which electrically disconnects the first and second electrodes from the conduction judging unit and electrically connects the first and second electrodes to the high-frequency current applying unit when the high-frequency current applying unit applies high-frequency current.

9. The fluid ejection device according to claim 1, further comprising:
a suction pipe which contains a suction opening provided in the vicinity of the fluid ejection opening and a passage through which a sucked object passes; and
a sucking force giving unit which gives sucking force for sucking object in the vicinity of the opening of the suction pipe.

10. The fluid ejection device according to claim 1, further comprising:
a connection flow path communicating with the outlet flow path at a first end and having the fluid ejection opening at a second end to transmit pulse of fluid flowing from the fluid chamber to the second end.

11. The fluid ejection device according to claim 10, wherein the connection flow path pipe is made of conductive material.

12. The fluid ejection device according to claim 1, wherein the fluid supplying unit has a pressure generating unit which generates pressure for supplying the fluid to the fluid chamber.

13. The fluid ejection device according to claim 1, wherein the operation control unit allows operation of the capacity changing unit when the conduction judging unit determines that conduction of the first electrode and the second electrode has been achieved, and prohibits operation of the capacity changing unit when the conduction judging unit determines that conduction of the first electrode and the second electrode is not achieved.

14. A driving method of a fluid ejection device comprising:
the fluid ejection device including
a fluid chamber whose capacity is variable,
an inlet flow path and an outlet flow path communicating with the fluid chamber,
a capacity changing unit which changes the capacity of the fluid chamber,
a fluid supplying unit which supplies fluid to the inlet flow path,
a fluid ejection opening disposed at an end of the outlet flow path opposite to an end communicating with the fluid chamber,
a first electrode having a first conductive contact portion contacting an ejection target object for the fluid and disposed at the fluid ejection opening or a component in the vicinity of the fluid ejection opening,
a second electrode having a polarity different from that of the first electrode and having a second conductive contact portion contacting the ejection target object,
a conduction judging unit which judges whether the first electrode and the second electrode are conducted, and
an operation control unit which controls operation of the capacity changing unit based on judgment result of the conduction judging unit;
judging conduction by causing the conduction judging unit to judge whether the first electrode and the second electrode are conducted; and
controlling operation of the capacity changing unit by causing the operation control unit to control the capacity changing unit based on judgment result of the conduction judging step.

15. An operating instrument which supports medical treatment for an affected portion by using ejection of fluid, comprising the fluid ejection device according to claim 1.
